(19) United States
(12) Patent Application Publication
(10) Pub. No.: US 2026/0197637 A1
(43) Pub. Date: Jul. 9, 2026

(54) METHODS AND APPARATUS FOR SELECTING A SECURITY PROFILE IN A WIRELESS COMMUNICATION SYSTEMS

(71) Applicant: Samsung Electronics Co., Ltd., Suwon-si, Gyeonggi-do (KR)

(72) Inventors: Ramesh Chandra VUPPALA, Bangalore (IN); Neha SHARMA, Bangalore (IN); Anshuman NIGAM, Bangalore (IN); Donghyun JE, Suwon-si (KR); Dongmyoung KIM, Suwon-si (KR)

(21) Appl. No.: 19/130,489

(22) PCT Filed: Dec. 12, 2023
(86) PCT No.: PCT/KR2023/020365

§ 371 Date: May 15, 2025

(30) Foreign Application Priority Data
Dec. 19, 2022 (IN) 202241073565
Oct. 27, 2023 (IN) 202241073565

(51) Int. Cl. H04W 12/033; H04L 9/08

(52) U.S. Cl. CPC H04W 12/033; H04L 9/0852

(57) ABSTRACT

The present disclosure relates to a 5G communication system or a 6G communication system for supporting higher data rates beyond a 4G communication system such as long term evolution (LTE). Embodiments disclosed herein relate to methods and systems for selecting a security profile in communication network. More specifically, embodiments disclosed herein relate to methods (500, 900, 2100) and systems (200) to perform a security profile selection procedure for wireless communication networks. The proposed method (500, 900, 2100) provides Post Quantum Cryptography (PQC) or quantum cryptography based security profile selection in wireless communication networks. The method (500, 900, 2100) discloses a plurality of post quantum based security profiles in User Equipment (UE) (202), mechanisms and procedures involved in selection of security profiles, which are mainly used in maintaining subscriber privacy during primary authentication procedure between the UE (202) and the communication network (204). The selected security profiles can be further used for data encryption between the UE (202) and the communication network (204). The mechanism dynamically selects the security profile that can provide better security in a given network environment.

### TECHNICAL FIELD

Embodiments disclosed herein relate to wireless communication networks, and more particularly to methods and systems to perform a security profile selection procedure for wireless communication networks.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The principal object of embodiments herein is to disclose methods and systems to perform a security profile selection procedure for wireless communication networks.

Another object of embodiments herein is to disclose methods and systems for Post Quantum Cryptography (PQC) or quantum cryptography based security profile selection in wireless communication networks.

Another object of embodiments herein is to disclose methods and systems to disclose a plurality of post quantum based security profiles in User Equipment (UE), mechanisms and procedures involved in selection of security profiles, which are mainly used in maintaining subscriber privacy during primary authentication procedure between the UE and the network.

Another object of embodiments herein is to disclose a mechanism to dynamically select the security profile that can provide better security in a given network environment.

Another object of embodiments herein is to disclose methods and systems that define the signalling procedure of profile selection procedure via core network, SIM provisioning based, Bearer independent based and machine learning based security profile selection in post quantum era, between the UE and network.

The present invention has been made to address at least the above problems and/or disadvantages and to provide at least the advantages described below. Accordingly, an aspect of the present invention provides a method and apparatus for selecting a security profile in a wireless communication systems.

### Solution to Problem

Accordingly, the embodiments herein provide a method for selecting a security profile in a communication network. The method comprises receiving, by a User Equipment (UE), a configuration of a new network service for a Universal Integrated Circuit Card (UICC) from the communication network. The UICC can include, but not limited to (Subscriber Identity Module) (SIM), Universal Subscriber Identity Module (USIM), embedded SIM (eSIM), integrated SIM, and so on. The UICC is configured with the new network service by the communication network during provisioning of the UICC. The method comprises configuring, by the UE, at least one security profile identifier in one of the UE and the UICC, for adding at least one security profile in a priority order. The method comprises selecting, by the UE, the security profile using the configured security profile identifier, based on the configured new network service.

Accordingly, the embodiments herein provide a UE having a processor. The processor is configured to receive a configuration of a new network service for a UICC from the communication network. The UICC is configured with the new network service by the communication network during provisioning of the UICC. The processor is configured to configure at least one security profile identifier in one of the UE and the UICC, for adding at least one security profile in a priority order. The processor is configured to select the security profile using the configured security profile identifier, based on the new network service.

Accordingly, the embodiments herein provide a method for selecting a security profile in a communication network. The method comprises receiving, by a UE, a message from the communication network. The message comprises at least one of a security support indication and a security profile indication supported by the communication network. The method comprises updating, by the UE, at least one security profile supported by the UE based on the received message. The method comprises sending, by the UE, a registration request to the communication network with at least one of a user identity encryption and a UE data encryption using the updated security profile.

Accordingly, the embodiments herein provide a UE having a processor. The processor is configured to receive a message from the communication network. The message comprises at least one of a security support indication and a security profile indication supported by the communication network. The processor is configured to update at least one security profile supported by the UE based on the received message. The processor is configured to send a registration request to the communication network with at least one of a user identity encryption and a UE data encryption using the updated security profile.

Accordingly, the embodiments herein provide a method for selecting a PQC profile in a communication network. The method comprises creating, by a UE, and training an Artificial Intelligence (AI) based model using at least one input comprising one of one or more UE parameters, one or more network parameters and one or more application parameters. The method comprises learning, by the UE, at least one PQC profile using the trained AI based model. The PQC profile can include, but not limited to a Quantum Key Distribution (QKD) profile. The method comprises sending, by the UE, the learned PQC profile to upper layers for at least one of a user identity encryption and a UE data encryption.

Accordingly, the embodiments herein provide a UE having a processor. The processor is configured to create and train a AI based model using at least one input comprising one of one or more UE parameters, one or more network parameters and one or more application parameters. The processor is configured to learn at least one PQC profile using the trained AI based model. The processor is configured to send the learned PQC profile to upper layers for at least one of the user identity encryption and the UE data encryption.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and apparatus for selecting a security profile in a wireless communication systems.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates a flow process for selecting a security profile in a communication network during Universal Integrated Circuit Card (UICC) provisioning, according to existing arts;

FIG. 2 illustrates a system for selecting a security profile in a communication network, according to embodiments as disclosed herein;

FIG. 3 illustrates a plurality of modules of the processor of UE, according to embodiments as disclosed herein;

FIG. 4 illustrates a dynamic security profile selection/update mechanism with multiple design options which are defined for selecting or updating one or more security profiles in a communication network, according to embodiments as disclosed herein;

FIG. 5 illustrates a method for selecting a security profile in the communication network through UICC provisioning, according to embodiments as disclosed herein;

FIG. 6 illustrates a flow process for selecting a security profile in a new network service independent of existing network service during UICC provisioning, according to embodiments as disclosed herein;

FIG. 7 illustrates a flow process for selecting a security profile in a new network service dependent of existing network service during UICC provisioning, according to embodiments as disclosed herein;

FIG. 8 illustrates a flow process for selecting a security profile in a new network service dependent of existing network service with security profile identifiers configured as separate sections, according to embodiments as disclosed herein;

FIG. 9 illustrates a method for selecting or updating a security profile based on a request from the communication network, according to embodiments as disclosed herein;

FIG. 10 illustrates a message sequence diagram for selecting or updating of PQC support via an identity request, according to embodiments as disclosed herein;

FIG. 11 illustrates a message sequence diagram for selecting or updating of security profile via an identity request, according to embodiments as disclosed herein;

FIG. 12 illustrates a message sequence diagram for selecting or updating PQC support via a registration reject, according to embodiments as disclosed herein;

FIG. 13 illustrates a message sequence diagram for selecting or updating of security profiles via a registration reject, according to embodiments as disclosed herein;

FIG. 14 illustrates a message sequence diagram for updating of PQC support via configuration update command or any N1 message through registration request, according to embodiments as disclosed herein;

FIG. 15 illustrates a message sequence diagram for updating of PQC support via configuration update command or any N1 message through identification request, according to embodiments as disclosed herein;

FIG. 16 illustrates a message sequence diagram for updating of security profile via configuration update command or any N1 message through registration request, according to embodiments as disclosed herein;

FIG. 17 illustrates a message sequence diagram for updating of security profile via configuration update command or any N1 message through identification request, according to embodiments as disclosed herein;

FIG. 18 illustrates a message sequence diagram for PQC/legacy support update or profile update via BIP session through registration request, according to embodiments as disclosed herein;

FIG. 19 illustrates a message sequence diagram for PQC/legacy support update or profile update via BIP session through identification request, according to embodiments as disclosed herein;

FIG. 20 illustrates a design of procedure for AI/ML based PQC profile selection, according to embodiments as disclosed herein; and

FIG. 21 illustrates a method for selecting a PQC profile in a communication network 204 through AI model, according to embodiments as disclosed herein.

FIG. 22 illustrates a user equipment (UE) in a wireless communication systems to which embodiments of the disclosure can be applied

FIG. 23 illustrates a base station in a wireless communication system to which embodiments of the disclosure can be applied.

FIG. 24 illustrates a network entity to which embodiments of the disclosure can be applied

### MODE FOR THE INVENTION

The principal object of embodiments herein is to disclose methods and systems to perform a security profile selection procedure for wireless communication networks.

Another object of embodiments herein is to disclose methods and systems for Post Quantum Cryptography (PQC) or quantum cryptography based security profile selection in wireless communication networks.

Another object of embodiments herein is to disclose methods and systems to disclose a plurality of post quantum based security profiles in User Equipment (UE), mechanisms and procedures involved in selection of security profiles, which are mainly used in maintaining subscriber privacy during primary authentication procedure between the UE and the network.

Another object of embodiments herein is to disclose a mechanism to dynamically select the security profile that can provide better security in a given network environment.

Another object of embodiments herein is to disclose methods and systems that define the signalling procedure of profile selection procedure via core network, SIM provisioning based, Bearer independent based and machine learning based security profile selection in post quantum era, between the UE and network.

Accordingly, the embodiments herein provide a method for selecting a security profile in a communication network. The method comprises receiving, by a User Equipment (UE), a configuration of a new network service for a Universal Integrated Circuit Card (UICC) from the communication network. The UICC can include, but not limited to (Subscriber Identity Module) (SIM), Universal Subscriber Identity Module (USIM), embedded SIM (eSIM), integrated SIM, and so on. The UICC is configured with the new network service by the communication network during provisioning of the UICC. The method comprises configuring, by the UE, at least one security profile identifier in one of the UE and the UICC, for adding at least one security profile in a priority order. The method comprises selecting, by the UE, the security profile using the configured security profile identifier, based on the configured new network service.

Accordingly, the embodiments herein provide a UE having a processor. The processor is configured to receive a configuration of a new network service for a UICC from the communication network. The UICC is configured with the new network service by the communication network during provisioning of the UICC. The processor is configured to configure at least one security profile identifier in one of the UE and the UICC, for adding at least one security profile in a priority order. The processor is configured to select the security profile using the configured security profile identifier, based on the new network service.

Accordingly, the embodiments herein provide a method for selecting a security profile in a communication network. The method comprises receiving, by a UE, a message from the communication network. The message comprises at least one of a security support indication and a security profile indication supported by the communication network. The method comprises updating, by the UE, at least one security profile supported by the UE based on the received message. The method comprises sending, by the UE, a registration request to the communication network with at least one of a user identity encryption and a UE data encryption using the updated security profile.

Accordingly, the embodiments herein provide a UE having a processor. The processor is configured to receive a message from the communication network. The message comprises at least one of a security support indication and a security profile indication supported by the communication network. The processor is configured to update at least one security profile supported by the UE based on the received message. The processor is configured to send a registration request to the communication network with at least one of a user identity encryption and a UE data encryption using the updated security profile.

Accordingly, the embodiments herein provide a method for selecting a PQC profile in a communication network. The method comprises creating, by a UE, and training an Artificial Intelligence (AI) based model using at least one input comprising one of one or more UE parameters, one or more network parameters and one or more application parameters. The method comprises learning, by the UE, at least one PQC profile using the trained AI based model. The PQC profile can include, but not limited to a Quantum Key Distribution (QKD) profile. The method comprises sending, by the UE, the learned PQC profile to upper layers for at least one of a user identity encryption and a UE data encryption.

Accordingly, the embodiments herein provide a UE having a processor. The processor is configured to create and train a AI based model using at least one input comprising one of one or more UE parameters, one or more network parameters and one or more application parameters. The processor is configured to learn at least one PQC profile using the trained AI based model. The processor is configured to send the learned PQC profile to upper layers for at least one of the user identity encryption and the UE data encryption.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

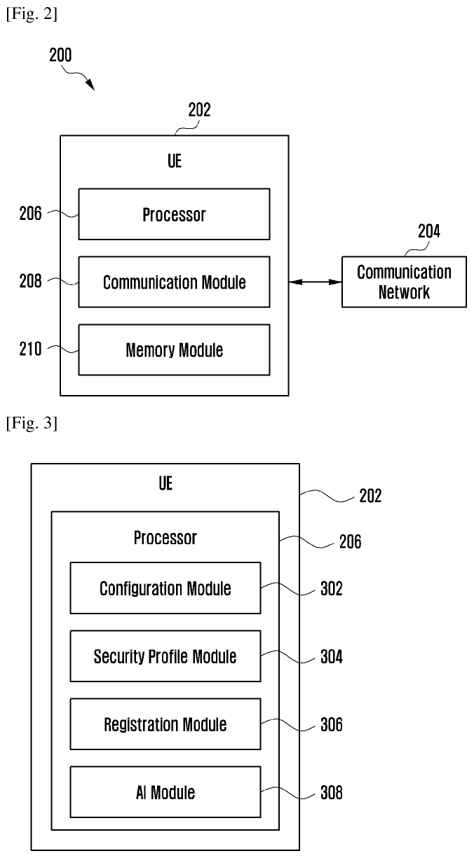

The embodiments herein disclose methods and systems to design mechanisms and procedures involved in selection of security profiles for wireless communication networks. Referring now to the drawings, and more particularly to FIGS. 2 through 21, where similar reference characters denote corresponding features consistently throughout the figures, there are shown embodiments.

In recent years, several broadband wireless technologies have been developed to meet the growing number of broadband subscribers for providing better applications and services. A Second-generation (2G) wireless communication system has been developed to provide voice services while ensuring the mobility of users. Third generation (3G) wireless communication system supports not only voice service, but also data service. In recent years, fourth generation (4G) wireless communication system has been developed to provide high-speed data service. However, currently, the 4G wireless communication systems suffer from lack of resources to meet the growing demand for high-speed data services. This problem is solved by the deployment of fifth generation (5G) wireless communication system to meet the ever-growing demand for high-speed data services. Furthermore, the 5G wireless communication system provides ultra-reliability and supports low latency applications.

A quantum computer is a computer, which makes use of quantum-mechanical effects. These effects include superposition, which allows quantum bits (qubits) to exist in a combination of several states at once, and entanglement, which allows connections between separate quantum systems such that they cannot be described independently. There exist quantum algorithms that use the quantum-mechanical effects to solve certain cryptographic problems more efficiently than they could be solved on a classical computer. Shor's quantum algorithm for integer factorization runs in polynomial time on a quantum computer. A variant of Shor's algorithm enables a quantum computer to calculate discrete algorithms in polynomial time, both over finite fields and elliptic curves. This variant renders several other public-key cryptosystems insecure, including Diffie-Hellman (DH) and Elliptic Curve Diffie-Hellman (ECDH). To counter the threat of quantum computing to asymmetric cryptography, it is necessary to swap existing algorithms for new, quantum-resistant algorithms also called as Post Quantum Cryptography (PQC) algorithms. Hence, there is a need for wireless communication networks like Beyond 5G (such as 6G) to quickly adapt to these PQC algorithms for enhanced security.

PQC involves multiple algorithms which are used for different purposes such as key establishment, digital signature, and so on. Some of the algorithms include CRYSTALS-KYBER for key-establishment and CRYSTALS-Dilithium, FALCON and SPHINCS+ for digital signatures which are post quantum secure.

In current systems (for example, a 5G system), the globally unique 5G Subscription Permanent Identifier is called SUPI as defined in 3GPP TS 23.501. A Subscription Concealed Identifier (SUCI) is a privacy preserving identifier containing the concealed SUPI. As per TS 33.501, the SUPI is privacy protected over-the-air by using the SUCI. The UE shall generate a SUCI using a protection scheme or security profile with the raw public key, i.e., the Home Network Public Key that was securely provisioned in control of the home network.

5G uses legacy asymmetric crypto algorithm, which may not be secure due to the development of quantum computing (QC) machine. In case of Beyond 5G, devices may support both legacy asymmetric crypto algorithm and/or PQC algorithm. Different devices may have different requirements and support of cryptography algorithms may vary accordingly.

The current profiles (or protection schemes) exist only for non-PQC algorithms such as null scheme, Elliptic Curve Integrated Encryption Scheme (ECIES) Profile A, ECIES Profile B, and so on. Null scheme based primary authentication is performed only when no security is required. ECIES Profile A and ECIES Profile B are based on Elliptical Curve Cryptography (ECC) and are prone to Quantum attacks. These profiles are configured in the Subscriber Identity Module (SIM) during provisioning and there is no dynamic way of choosing various profiles. As provided in Table 1 below, only highest priority profile in Universal Subscriber Identity Module (USIM) elementary file ‘EF SUCI_Calc_Info’ needs to be selected by default for primary authentication (or) SUCI encryption as per 3GPP TS 31.102 specification. 3GPP has mentioned one or more profiles of protection schemes for concealing the SUPI in Annex C of TS 33.501 specification.

TABLE 1

| | | | Length |
|---|---|---|---|
| Description | Value | M/O/C | (bytes) |
| Protection Scheme Identifier List data object tag | ‘A0’ | M | 1 |
| Protection Scheme Identifier List data object length | L1 | M | Note 1 |
| Protection Scheme Identifier 1 (Highest priority) | — | O | 1 |
| Key Index 1 | | C (Note 2) | 1 |
| Protection Scheme Identifier 2 | | O | 1 |
| Key Index 2 | | C (Note 2) | 1 |
| . . . | . . . | . . . | . . . |
| Protection Scheme Identifier N (Lowest priority) | | O | 1 |
| Key Index N | — | C (Note 2) | 1 |

Note 1:
The length is coded according to ISO/IEC 8825-1
Note 2:
This field is present only if the corresponding Protection Scheme Identifier field is present

In 5G or beyond 5G networks, both legacy as well as new crypto algorithms which can be based on quantum algorithms such as Quantum key distribution or PQC may be applicable. Therefore, new profiles need to be defined that can be used for protection schemes for concealing the SUPI.

In 5G systems, since there are limited (only two) protection scheme profiles supported by 3GPP for primary authentication, there are no methods to dynamically select or update the protection schemes. In beyond 5G networks (as it supports both legacy as well as new crypto algorithm say PQC algorithms), there may be multiple profiles available with the user or any other device. Therefore, there does not exist a mechanism to dynamically select the protection scheme or profile that can provide better security in given network environment. Also, if the UE and the network support different protection schemes, then the UE may not be able to perform successful registration due to authentication procedure failure which may further delay in registration procedure. Hence, a proper negotiation of protection scheme procedures is required between the UE and the network.

At present, in Embedded Universal Integrated Circuit Card (eUICC), there is only provision for the UE is to decide whether to perform SUCI encryption or not, and whether the SUCI encryption can be performed by the USIM/Mobile Equipment (ME). The UE cannot decide whether if the SUCI encryption needs to be performed using PQC algorithms or not. Network service support is the configuration provided by the network during SIM provisioning. Network services include such as service n°124 is for Subscription identifier privacy support, and service n°125 is for SUCI calculation by the USIM.

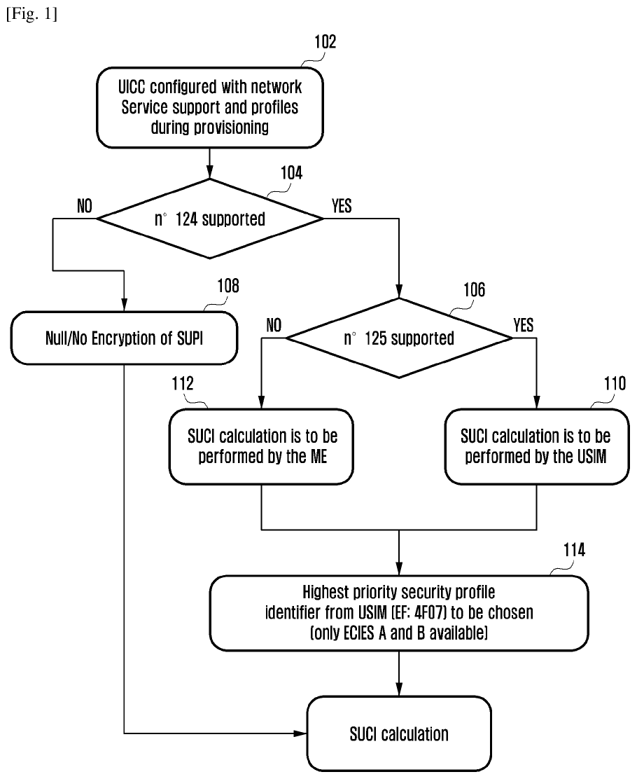

FIG. 1 illustrates a flow process for selecting a security profile in a communication network during SIM provisioning. As depicted in step 102, the SIM is configured with network service support and security profiles during provisioning. The UE 202 verifies if the configured network service n°124 is supported, as depicted in step 104. The UE 202 verifies the network service n°125, as depicted in step 106, if the network service n°124 is supported. Else, null or no encryption of SUPI is performed, as depicted in step 108.

The UE 202 performs the SUCI calculation by Universal Subscriber Identity Module (USIM), as depicted in step 110, if the network service n°125 is supported. Else, SUCI calculation is to be performed by the ME, as depicted in step 112. The UE 202 selects highest priority security profile identifier from the USIM (EF: 4F07), where only ECIES A and B available, as depicted in step 114, for SUCI calculation.

As depicted in Table 2 below and FIG. 1, there is no network service support where either legacy or PQC algorithm needs to be selected for SUCI concealment.

TABLE 2

| Network Service Support in SIM | | |
|---|---|---|
| n °124 Available | n °125 Available | Functionality of SUCI |
| ✓ | ✓ | SUCI calculation is to be performed by the USIM |
| ✓ | x | SUCI calculation is to be performed by the ME. |
| x | x | Null/No Encryption of SUPI |

Currently there is provision for only one highest priority protection scheme or security profile identifier defined in 3GPP 31.102 (EF SUCI_Calc_Info), which acts as default and only support legacy non-PQC algorithms. Due to introduction on PQC based algorithms, if UE (or) network capable of supporting both legacy and PQC algorithms, then the UE or network cannot choose default of both types of profiles. Hence, there does not exist multiple default security profile identifiers.

Hence, there is a need in the art for solutions which will overcome the above mentioned drawback(s), among others.

FIG. 2 illustrates a system 200 for selecting a security profile in a communication network 204. The system 200 comprises a User Equipment (UE) 202 and a communication network 204 for performing security profile selection procedure. The UE 202 further comprises a processor 206, a communication module 208, and a memory module 210.

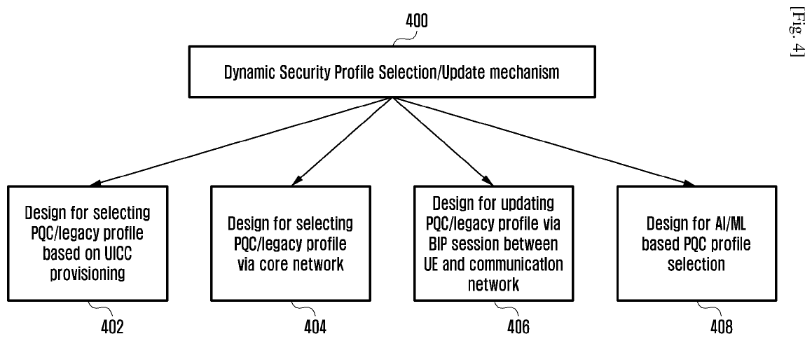

In an embodiment herein, the processor 206 is configured with a procedure for Post Quantum Cryptography (PQC) or legacy profile selection based on Universal Integrated Circuit Card (UICC) provisioning. The UICC can include, but not limited to (Subscriber Identity Module) (SIM), Universal Subscriber Identity Module (USIM), embedded SIM (eSIM), integrated SIM, and so on. The processor 206 is configured with a procedure for PQC or legacy profile selection by a core network. The processor 206 is configured with a procedure for PQC or legacy profile update via Bearer Independent Protocol (BIP) session between the UE 202 and the communication network 204. The processor 206 is configured with a procedure for Artificial Intelligence (AI)/Machine Learning (ML) based PQC profile selection. The processor 206 further comprises a configuration module 302, a security profile module 304, a registration module 306, and an AI module 308, as depicted in FIG. 3.

In an embodiment herein, the UE 202 receives a configuration of a new network service for a UICC from the communication network 204 where the UICC is configured with the new network service by the communication network 204 during provisioning of the UICC. The new network service can be one of an independent network service and a dependent network service. The independent network service is independent of an existing network service. The dependent network service is dependent of the existing network service. The new network service is configured in the UICC to enable use of one or more PQC algorithms for performing at least one of a user identity encryption and a UE data encryption. In an embodiment herein, the UICC can be configured with the new network service by the communication network 204 before provisioning the UICC in the UE 202, and the configured UICC can be provisioned in the UE 202.

In an embodiment herein, the configuration module 302 can receive the configuration of the new network service for the UICC. The configuration module 302 can configure at least one security profile identifier in one of the UE 202 and the UICC for adding at least one security profile in a priority order. In an embodiment herein, the security profile identifier is configured as a combined section for a legacy profile and a PQC profile. In an embodiment herein, one or more security profile identifiers are configured as separate sections for the legacy profile and the PQC profile.

In an embodiment herein, the security profile module 304 can be stored with one or more security profiles. The security profile module 304 can select a security profile from the stored security profiles using the configured security profile identifier. The security profile module 304 can select the security profile based on the configured new network service. The security profile comprises at least one of the legacy profile and the PQC profile.

In an embodiment herein, the security profile module 304 can verify the configured new network service. The security profile module 304 can perform at least one of the user identity encryption and the UE data encryption using the PQC profile, if the configured new network service is the independent network service and is enabled. The security profile module 304 can perform at least one of the user identity encryption and the UE data encryption using the legacy profile, if the configured new network service is the independent network service and is disabled. The security profile module 304 can select the security profile identifier of at least one of the legacy profile and the PQC profile with high priority.

In an embodiment herein, the security profile module 304 can verify the configured new network service. The security profile module 304 can perform at least one of the user identity encryption and the UE data encryption using the PQC profile, if the configured new network service is the dependent network service, and the existing network service and the dependent network service both are enabled. The security profile module 304 can perform at least one of the user identity encryption and the UE data encryption using the legacy profile, if the configured new network service is the dependent network service, and one of the existing network service and the dependent network service is disabled. The security profile module 304 can select the security profile identifier of at least one of the legacy profile and the PQC profile with high priority.

In an embodiment herein, the security profile module 304 can receive a message from the communication network 204. The message comprises at least one of a security support indication and a security profile indication supported by the communication network 204. The security support indication comprises one of a PQC support indication and a legacy support indication. The security profile indication comprises one of a PQC profile indication supported by the communication network 204 and a legacy profile indication supported by the communication network 204. The security profile module 304 can update at least one security profile supported by the UE 202 based on the received security support indication and the security profile indication supported by the communication network 204. In an embodiment herein, the message from the communication network 204 can comprise at least one of an identity request message, a registration reject message, a System Information Block (SIB)/Master Information Block (MIB) message, a Radio Resource Control (RRC) message, a BIP message, a N1 message, and so on. In an embodiment herein, the communication network 204 adds a cause code in the registration reject message, if the message is the registration reject message. The communication network 204 adds the cause code for requesting the UE 202 to share at least one of the user identity encryption and the UE data encryption with a new type of the security profile from a next registration request or a message response. The communication network 204 adds an information element in the message for at least one of a security support and the security profile for indicating the UE 202, a type of encryption required for at least one of the user identity encryption and the UE data encryption. In an embodiment herein, the N1 message can comprise a configuration update command message for requesting the UE 202 to share at least one of the user identity encryption and the UE data encryption with a new type of the security profile from a next registration request or a message response.

In an embodiment herein, the registration module 306 can send a registration request to the communication network 204 with at least one of the user identity encryption and the UE data encryption using the updated security profile. The registration module 306 can send the registration request to the communication network 204 with a Subscription Concealed Identifier (SUCI) encrypted using the updated security profile.

In an embodiment herein, the AI module 308 can create and train a AI based model using at least one input comprising one of one or more, UE parameters, one or more network parameters and one or more application parameters. The AI module 308 can learn at least one PQC profile using the trained AI based model. The PQC profile can include, but not limited to a Quantum Key Distribution (QKD) profile. The AI module 308 can send the learned at least one PQC profile to upper layers for at least one of the user identity encryption and the UE data encryption.

In an embodiment herein, the processor 206 can process and execute data of a plurality of modules of the UE 202 respectively. The processor 206 can be configured to execute instructions stored in the memory module 210. The processor 206 may comprise one or more of microprocessors, circuits, and other hardware configured for processing. The processor 206 can be at least one of a single processer, a plurality of processors, multiple homogeneous or heterogeneous cores, multiple Central Processing Units (CPUs) of different kinds, microcontrollers, special media, and other accelerators. The processor 206 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 206 of the UE 202 can communicate via the communication module 208. The communication module 208 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 210 may comprise one or more volatile and non-volatile memory components which are capable of storing data and instructions of the modules of the UE 202 to be executed. Examples of the memory module 210 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 210 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 210 may, in some examples, be considered a non-transitory storage medium. The term “non-transitory” may indicate that the storage medium is not embodied in a carrier wave or a propagated signal. However, the term “non-transitory” should not be interpreted to mean that the memory module 210 is non-movable. In certain examples, a non-transitory storage medium may store data that can, over time, change (for example, in Random Access Memory (RAM) or cache).

FIG. 2 shows example modules of the UE 202 respectively, but it is to be understood that other embodiments are not limited thereon. In other embodiments, the UE 202 may include less or more number of modules. Further, the labels or names of the modules are used only for illustrative purpose and does not limit the scope of the invention. One or more modules can be combined together to perform same or substantially similar function in the UE 202.

FIG. 4 illustrates a dynamic security profile selection/update mechanism 400 with multiple design options which are defined for selecting or updating one or more security profiles in a communication network 204. The design options comprise a design for selecting PQC/legacy profile based on UICC provisioning as depicted at 402, a design for selecting PQC/legacy profile via core network as depicted at 404, a design for updating PQC/legacy profile via BIP session between the UE 202 and the communication network 204 as depicted at 406, and a design of procedure for AI/ML based PQC profile selection as depicted at 408.

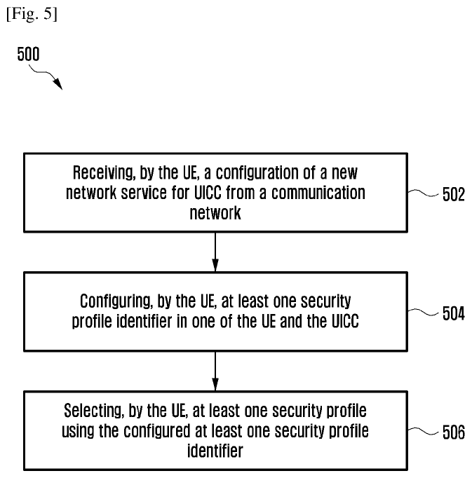

FIG. 5 illustrates a method 500 for selecting a security profile in the communication network 204 through UICC provisioning. The method 500 comprises receiving, by the UE 202, a configuration of a new network service for a UICC, as depicted in step 502, from the communication network 204. The UICC is configured with the new network service by the communication network 204 during provisioning of the UICC. The method 500 further comprises configuring, by the UE 202, at least one security profile identifier in one of the UE 202 and the UICC, as depicted in step 504, for adding at least one security profile in a priority order. The method 500 comprises selecting, by the UE 202, at least one security profile using the configured at least one security profile identifier, as depicted in step 506, based on the configured new network service.

The various actions in method 500 may be performed in the order presented, in a different order or simultaneously. Further, in some embodiments, some actions listed in FIG. 5 may be omitted.

In an embodiment herein, the security profile selection based on UICC provisioning can be provided in two steps. First step includes creating a new network service during provisioning of UICC. The new network service can be independent of other network services. The new network service can be dependent of existing network service. Second step includes configuring new Elementary Files (EF) such as security profile identifiers to accommodate new security profiles of UICC. The new security profiles of UICC are defined in EFSUCI_Calc_Info and/or EFPQC_SUCI_Calc_Info. The security profile identifiers can be configured as a combined section for the legacy profile and the PQC profile. The security profile identifiers can be configured as multiple separate sections for different security profiles such as legacy profile and the PQC profile.

For example, based on the new network service in UICC, default legacy and PQC security profiles mentioned with high priority in EFSUCI_Calc_Info and/or EFPQC_SUCI_Calc_Info can be selected. For example, the default option can be selecting PQC profiles as per UICC provisioning.

In an embodiment herein, a new network service is independent of existing network service and configured to consider PQC algorithm for Subscription Permanent Identifier (SUPI) to SUCI encryption. In this scenario, if the new network service is declared available or enabled, then the SUCI calculation is to be performed by PQC algorithms. Else, if the new network service is declared unavailable or disabled, then the SUCI calculation to be performed by legacy algorithms.

Following modification required to incorporate in 3GPP TS 31.102.

4.2.8 Elementary File USIM Service Table (EF UST) for new network service independent of existing network service.

| | |
|---|---|
| Service n ° XXX (or 145) | SUCI support for PQC algorithms |

### 4.4.11 Contents of Files at the DF_{5GS} Level

### 4.4.11.1 Introduction

| | |
|---|---|
| Service n ° XXX | PQC based SUCI calculation |

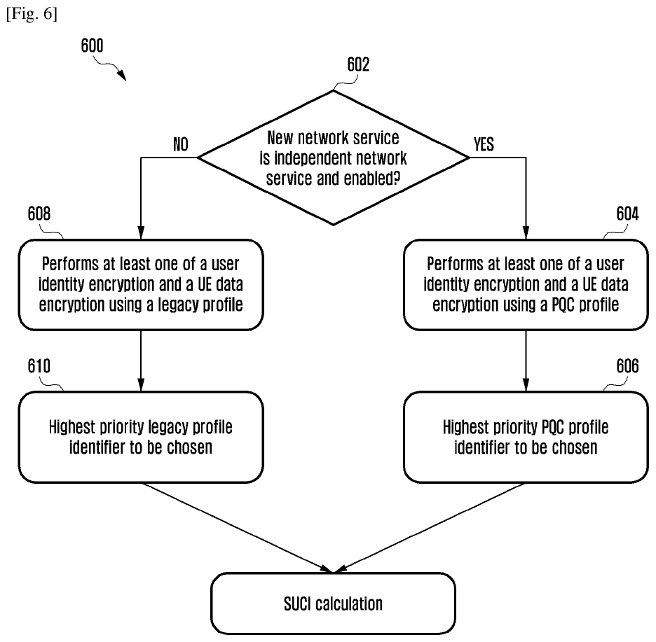

FIG. 6 illustrates a flow process 600 for selecting a security profile in a new network service independent of existing network service during UICC provisioning. As depicted in step 602, the UE 202 verifies if the configured new network service is independent of existing network service. If the configured new network service is the independent network service and is enabled, then the UE 202 performs at least one of a user identity encryption and a UE data encryption using the PQC profile, as depicted in step 604. For example, SUCI calculation is to be performed by the PQC algorithm. The UE 202 selects highest priority PQC profile identifier, as depicted in step 606. If the configured new network service is the independent network service and is disabled, then the UE 202 performs at least one of the user identity encryption and the UE data encryption using the legacy profile, as depicted in step 608. For example, SUCI calculation is to be performed by the legacy algorithm. The UE 202 selects highest priority legacy profile identifier, as depicted in step 610, for SUCI calculation.

The various actions in method 600 may be performed in the order presented, in a different order or simultaneously. Further, in some embodiments, some actions listed in FIG. 6 may be omitted.

In an embodiment herein, a new network service is dependent of existing network service and configured to consider PQC algorithm for Subscription Permanent Identifier (SUPI) to SUCI encryption. Table 3 depicts SUCI functionality for the new network service which is dependent of existing network service.

TABLE 3

| Network Service Support in SIM | | | |
|---|---|---|---|
| | | n ° XXX | |
| n °124 Available | n °125 Available | Available | Functionality of SUCI |
| ✓ | ✓ | ✓ | SUCI calculation is to be performed by the |
| | | | USIM using PQC algorithm |
| ✓ | x | ✓ | SUCI calculation is to be performed by the |
| | | | ME using PQC algorithm. |
| ✓ | ✓ | x | SUCI calculation is to be performed by the |
| | | | USIM using non PQC algorithm (Can be |
| | | | legacy like ECIES) |
| ✓ | x | x | SUCI calculation is to be performed by the |
| | | | ME using non PQC algorithm (Can be legacy |
| | | | like ECIES) |
| x | x | x | Null/No Encryption of SUPI |

As shown in Table 3, if existing service n° 124 and the new network service n°XXX are declared “available”, then the SUCI calculation is to be performed by PQC algorithm. If existing service n°124 is declared “available” and the new network service n°XXX is not declared “available”, then the SUCI calculation is to be performed by legacy methods.

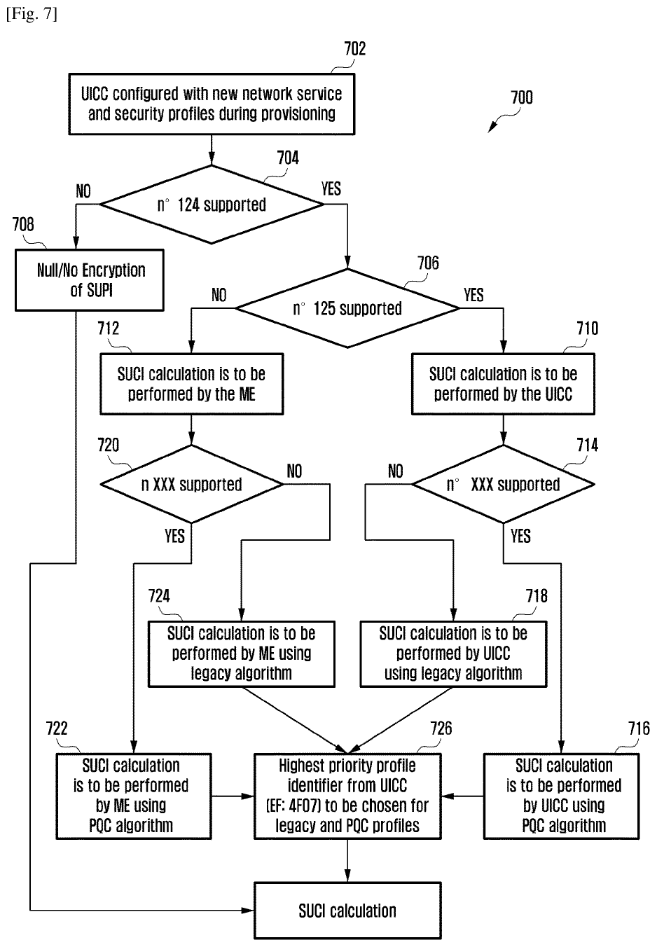

FIG. 7 illustrates a flow process 700 for selecting a security profile in a new network service dependent of existing network service during UICC provisioning. As depicted in step 702, the UICC is configured with the new network service and security profiles during provisioning. The UE 202 verifies if the configured new network service is the dependent network service and the dependent network service (for example, n°124) is supported, as depicted in step 704. The UE 202 verifies the existing network service (for example, n°125), as depicted in step 706, if the dependent network service n°124 is supported. Else, null or no encryption of SUPI is performed, as depicted in step 708. The UE 202 performs the SUCI calculation by UICC, as depicted in step 710, if the existing network service n°125 is supported. Else, SUCI calculation is to be performed by the ME, as depicted in step 712.

Later, at step 714, the new network service n°XXX support is verified by the UE 202, after the step 710 of SUCI calculation is to be performed by the UICC. The SUCI calculation is to be performed by the UICC using PQC algorithm, as depicted in step 716, if the new network service n°XXX is supported by the UE 202. The new network service n°XXX support is verified by the UE 202, as depicted in step 720, after the step 712 of SUCI calculation is to be performed by the Mobile Equipment (ME). The SUCI calculation is to be performed by the ME using PQC algorithm, as depicted in step 722, if the new network service n°XXX is supported by the UE 202. Thus, the UE 202 performs at least one of the user identity encryption and the UE data encryption using the PQC profile, if the configured new network service is the dependent network service, and the existing network service and the dependent network service both are enabled.

Else, SUCI calculation is to be performed by the UICC and ME using legacy algorithm, as depicted in steps 718 and 724. Thus, the UE 202 performs at least one of the user identity encryption and the UE data encryption using the legacy profile, if the configured new network service is the dependent network service, and one of the existing network service and the dependent network service is disabled. The UE 202 selects highest priority security profile identifier from the UICC (EF: 4F07) for at least one of the legacy profile and the PQC profile, as depicted in step 726, for SUCI calculation. This step depicts a security profile configuration as a combined section for legacy and PQC security profiles.

The various actions in method 700 may be performed in the order presented, in a different order or simultaneously. Further, in some embodiments, some actions listed in FIG. 7 may be omitted.

Therefore, the new network service n°XXX shall only be taken into account if service n°124 is declared “available”. If service n°124 and service n°125 are declared “available”, the “PQC based SUCI calculation is to be performed by the UICC”. If service n°124 is declared “available” and service n°125 is not declared “available”, the “PQC SUCI calculation is to be performed by the ME”.

### 5.3.XX PQC Based SUCI Calculation Information Procedure

Requirement: “PQC based SUCI calculation is to be performed by the ME” (i.e., service n°124 and service n° XXX is “available”, service n°125 is not “available”).

Request: As part of the SUCI calculation performed by the ME, the ME performs the reading procedure with EFSUCI_Cale_Info or EFPQC_SUCI_Cale_Info.

### 5.3.XX PQC Based SUCI Calculation by the USIM Procedure

Requirement: “PQC SUCI calculation is performed by the USIM” (i.e., service n°124, service n°125, and service n°XXX are “available”).

Request: The ME uses the GET IDENTITY command in SUCI context to retrieve the SUCI calculated by the USIM.

In an embodiment herein, new PQC profiles being added can be configured in USIM/ME in 2 options.

Option 1: Combined section for legacy and PQC security profiles (as depicted in step 726 of FIG. 7)

Option 2: Multiple sections for different security profile configurations: one for legacy and one for PQC.

Default security profiles need to be configured for both PQC and legacy algorithms separately. Based on different combinations of UE 202 and network support for PQC and legacy algorithms one or multiple security profiles can be used simultaneously.

In an embodiment herein, for combined section for legacy and PQC security profile configuration, new security profile identifier to be introduced for PQC and one of them need to be chosen for default (like on highest priority). Both legacy and PQC algorithms can be part of combined section of UE 202 or UICC (EF 4F07). Based on UE 202 or the communication network support for PQC, highest priority security profile identifier of PQC or legacy can be chosen.

Table 4 shows 3GPP 31.102:4.4.11.8 EF SUCI_Calc_Info (Subscription Concealed Identifier Calculation Information EF) (ID: 4F07).

TABLE 4

| | | | Length |
|---|---|---|---|
| Description | Value | M/O/C | (bytes) |
| Security Profile Identifier List data object tag | ‘A0’ | M | 1 |
| Security Profile Identifier List data object length | L1 | M | Note 1 |
| Security Profile Identifier 1 (Highest priority) | — | O | 1 |
| Kcy Index 1 | — | C (Note 2) | 1 |
| PQC Security Profile Identifier 1 (Highest priority) | — | O | 1 |
| Key Index 2 | — | C (Note 2) | 1 |
| . . . | . . . | . . . | . . . |
| Security Profile Identifier N (Lowest priority) | — | O | 1 |
| Key Index N | — | C (Note 2) | 1 |

Note 1:
The length is coded according to ISO/IEC 8825-1
Note 2:
This field is present only if the corresponding Security Profile Identifier field is present

Table 5 indicates file details of EFSUCI_Cale_Info (Subscription Concealed Identifier Calculation Information EF)

TABLE 5

| Identifier: ‘4FXX’ | Structure: transparent | | Optional |
|---|---|---|---|
| SFI: ‘XX’ | | | |
| File size: X bytes (X ≥ 2) | | Update activity: low | |
| Access Conditions: | | | |
| READ PIN | | | |
| UPDATE ADM | | | |
| DEACTIVATE ADM | | | |
| ACTIVATE ADM | | | |
| Bytes | Description | M/O | Length |
| 1 to x | Security Profile identifier List | M | Z bytes |
| | data object | | |
| x to Z | PQC Security Profile identifier | M | Z bytes |
| | List data object | | |
| Z + 1 to Y + Z | Home Network Public Key List | C | Y bytes |
| | data object | | |

If “PQC based SUCI calculation is to be performed” (i.e., service n°124 is “available” in EF_{UST} and service n°XXX is “available” in EF_{UST}), this file shall have additional values of PQC profile.

If “PQC based SUCI calculation is not to be performed” (i.e. service n°124 is “available” in EF_{UST} and service n° XXX is not “available” in EF_{UST}), this file shall not have additional values of PQC profile.

If service n°124 is not “available” in EF_{UST}, this file shall not be available to the ME.

Note: How the file is made “not available to the ME” is implementation specific, for example, the file may not be present, the file may be present but not readable by the ME, or the file may be present but deactivated.
PQC security profile identifier list data object.

Contents: If PQC security profile identifier list data object length is not zero, this data object contains a list of the PQC security profile identifier and the corresponding Key Index. The first PQC security profile identifier entry has the highest priority and the last PQC security profile identifier entry has the lowest priority. The Key Index value indicates the position of the Home Network Public Key in the Home Network Public Key list that is applicable to the PQC profile.

Table 6 indicates coding for configured combined section of legacy and PQC security profiles.

TABLE 6

| Description | Value | M/O/C | Length (bytes) |
|---|---|---|---|
| Protection Scheme Identifier | ‘A0’ | M | 1 |
| List data object tag | | | |
| Protection Scheme Identifier | L1 | M | Note 1 |
| List data object length | | | |
| Protection Scheme Identifier 1 | — | O | 1 |
| (Highest priority) | | | |
| Key Index 1 | — | C (Note 2) | 1 |
| . . . | . . . | . . . | . . . |
| PQC Protection Scheme | ‘A1’ | M | 1 |
| Identifier List data object tag | | | |
| PQC Protection Scheme | L1 | M | Note 1 |
| Identifier List data object length | | | |
| PQC Protection Scheme | — | O | 1 |
| Identifier 1 (Highest priority) | | | |
| Key Index 1 | — | C (Note 2) | 1 |
| . . . | . . . | . . . | . . . |
| PQC Protection Scheme | — | O | 1 |
| Identifier N (Lowest priority) | | | |
| Key Index N | — | C (Note 2) | 1 |

Note 1:
The length is coded according to ISO/IEC 8825-1
Note 2:
This field is present only if the corresponding Protection Scheme Identifier field is present

In an embodiment herein, multiple sections for different security profile configurations: one for legacy and one for PQC include new security profile identifier to be introduced for PQC and one of them need to be chosen for default (like on highest priority). Legacy and PQC algorithms can be part of different EFs of UICC, EF 4F07 and EF 4FXX respectively. Based on the UE 202 or the communication network support for PQC, highest priority profile identifier of PQC or legacy can be chosen. New EF PQC_SUCI_Calc_Info need to be added in UICC application (3GPP 31.102). EF PQC_SUCI_Calc_Info is PQC Subscription Concealed Identifier Calculation Information EF (ID: 4FXX).

Table 7 indicates EF SUCI_Calc_Info for Legacy (EF: 4F07)

TABLE 7

| | | | Length |
|---|---|---|---|
| Description | Value | M/O/C | (bytes) |
| Protection Scheme Identifier List data | ‘A0’ | M | 1 |
| object tag | | | |
| Protection Scheme Identifier List data | L1 | M | Note 1 |
| object length | | | |
| Protection Scheme Identifier 1 | — | O | 1 |
| (Highest priority) | | | |
| Key Index 1 | — | C (Note 2) | 1 |
| Protection Scheme Identifier 2 | — | O | 1 |
| Key Index 2 | — | C (Note 2) | 1 |
| . . . | . . . | . . . | . . . |
| Protection Scheme Identifier N | — | O | 1 |
| (Lowest priority) | | | |
| Key Index N | — | C (Note 2) | 1 |

Note 1:
The length is coded according to ISO/IEC 8825-1
Note 2:
This field is present only if the corresponding Protection Scheme Identifier field is present

Table 8 indicates EF_PQC_SUCI_Calc_Info for PQC (EF: 4FXX).

TABLE 8

| | | | Length |
|---|---|---|---|
| Description | Value | M/O/C | (bytes) |
| PQC Protection Scheme | ‘A0’ | M | 1 |
| Identifier List data object | | | |
| tag | | | |
| PQC Protection Scheme | L1 | M | Note 1 |
| Identifier List data object | | | |
| length | | | |
| PQC Protection Scheme | — | O | 1 |
| Identifier 1 (Highest | | | |
| priority) | | | |
| Key Index 1 | — | C (Note 2) | 1 |
| PQC Protection Scheme | — | O | 1 |
| Identifier 2 | | | |
| Key Index 2 | — | C (Note 2) | 1 |
| . . . | . . . | . . . | . . . |
| PQC Protection Scheme | — | O | 1 |
| Identifier N (Lowest | | | |
| priority) | | | |
| Key Index N | — | C (Note 2) | 1 |

Note 1:
The length is coded according to ISO/IEC 8825-1
Note 2:
This field is present only if the corresponding Protection Scheme Identifier field is present

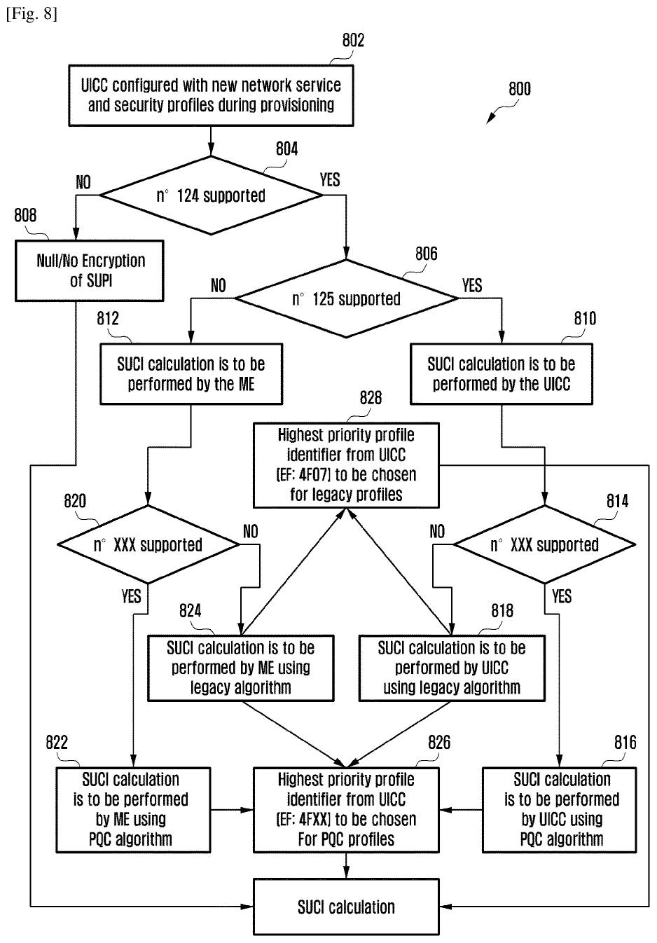

FIG. 8 illustrates a flow process 800 for selecting a security profile in a new network service dependent of existing network service with security profile identifiers configured as separate sections. As depicted in step 802, the UICC is configured with the new network service and security profiles during provisioning. The UE 202 verifies if the configured new network service is the dependent network service and the dependent network service (for example, n°124) is supported, as depicted in step 804. The UE 202 verifies the existing network service (for example, n°125), as depicted in step 806, if the dependent network service n°124 is supported. Else, null or no encryption of SUPI is performed, as depicted in step 808. The UE 202 performs the SUCI calculation by UICC, as depicted in step 810, if the existing network service n°125 is supported. Else, SUCI calculation is to be performed by the ME, as depicted in step 812.

Later, at step 814, the new network service n° XXX support is verified by the UE 202, after the step 810 of SUCI calculation is to be performed by the UICC. The SUCI calculation is to be performed by the UICC using PQC algorithm, as depicted in step 816, if the new network service n°XXX is supported by the UE 202. The new network service n° XXX support is verified by the UE 202, as depicted in step 820, after the step 812 of SUCI calculation is to be performed by the Mobile Equipment (ME). The SUCI calculation is to be performed by the ME using PQC algorithm, as depicted in step 822, if the new network service n°XXX is supported by the UE 202. Thus, the UE 202 performs at least one of the user identity encryption and the UE data encryption using the PQC profile, if the configured new network service is the dependent network service, and the existing network service and the dependent network service both are enabled. The UE 202 selects highest priority security profile identifier from the UICC (EF: 4FXX) for the PQC profiles, as depicted in step 826, for SUCI calculation.

Else, SUCI calculation is to be performed by the UICC and ME using legacy algorithm, as depicted in steps 818 and 824. Thus, the UE 202 performs at least one of the user identity encryption and the UE data encryption using the legacy profile, if the configured new network service is the dependent network service, and one of the existing network service and the dependent network service is disabled. The UE 202 selects highest priority security profile identifier from the UICC (EF: 4F07) for the legacy profiles, as depicted in step 828, for SUCI calculation. This step depicts a security profile configuration as separate sections for legacy and PQC security profiles.

The various actions in method 800 may be performed in the order presented, in a different order or simultaneously. Further, in some embodiments, some actions listed in FIG. 8 may be omitted.

Table 9 and Table 10 indicate coding for configured separate sections for legacy and PQC security profiles.

TABLE 9

| Identifier: | Structure: transparent | Optional | |
|---|---|---|---|
| ‘4FXX’ | | | |
| SFI: ‘XX’ | | | |
| File size: X | Update activity: low | | |
| bytes (X ≥ 2) | | | |
| Access Conditions: | | | |
| READ | PIN | | |
| UPDATE | ADM | | |
| DEACTIVATE | ADM | | |
| ACTIVATE | ADM | | |
| Bytes | Description | M/O | Length |
| 1 to Z | PQC Protection Scheme Identifier List | M | Z bytes |
| | data object | | |
| Z + 1 to | Home Network Public Key List data | C | Y bytes |
| Y + Z | object | | |

TABLE 10

| | | | Length |
|---|---|---|---|
| Description | Value | M/O/C | (bytes) |
| PQC Protection Scheme Identifier List | ‘A0’ | M | 1 |
| data object tag | | | |
| PQC Protection Scheme Identifier List | L1 | M | Note 1 |
| data object length | | | |
| PQC Protection Scheme Identifier 1 | — | O | 1 |
| (Highest priority) | | | |
| Key Index 1 | — | C (Note 2) | 1 |
| PQC Protection Scheme Identifier 2 | — | O | 1 |
| Key Index 2 | — | C (Note 2) | 1 |
| . . . | . . . | . . . | . . . |
| PQC Protection Scheme Identifier N | — | O | 1 |
| (Lowest priority) | | | |
| Key Index N | — | C (Note 2) | 1 |

Note 1:
The length is coded according to ISO/IEC 8825-1
Note 2:
This field is present only if the corresponding Protection Scheme Identifier field is present

### 4.4.11.XX EF_{PQC_SUCI_Calc_Info} (PQC Subscription Concealed Identifier Calculation Information EF)

If “PQC based SUCI calculation is to be performed” (i.e. service n°124 is “available” in EF_{UST} and service n°XXX is “available” in EF_{UST}), this file shall be present. This EF contains information needed by the ME for the support of subscription identifier privacy as defined in 3GPP TS 33.501.

If “PQC based SUCI calculation is not to be performed” (i.e. service n°124 is “available” in EF_{UST} and service n°XXX is not “available” in EF_{UST}), this file shall not be available to the ME.

If service n°124 is not “available” in EF_{UST}, this file shall not be available to the ME.

Note: How the file is made “not available to the ME” is implementation specific, for example, the file may not be present, the file may be present but not readable by the ME, or the file may be present but deactivated.
PQC profile identifier list data object.

Contents: This data object shall always be present. If PQC profile identifier list data object length is not zero, this data object contains a list of the PQC profile identifier and the corresponding Key Index. The first PQC profile identifier entry has the highest priority and the last PQC profile identifier entry has the lowest priority. The Key Index value indicates the position of the home network public key in the home network public key list that is applicable to the PQC profile.

### 4.7 Files of USIM

This clause contains file structure of the Universal Integrated Circuit Card (UICC) and the Application Dedicated File (ADF)_{USIM}. ADF_{USIM} shall be selected using the Application Identifier (AID) and information in EF_{DIR}.

DF5GS
EF_{PQC}_{_{—}}_{SUCI}_{_{—}}_{Calc}_{_{—}}_{Info}
‘4FXX’

Table 11 indicates Annex A (informative): EF changes via data download or USIM Application Toolkit (USAT) applications.

TABLE 11

| File | | Change |
|---|---|---|
| identification | Description | advised |
| 4FXX′ | PQC based Subscriber Concealed Identifier | Yes |
| | Calculation Information | |

Table 12 indicates Annex E (informative): Suggested contents of the EFs at prepersonalization.

TABLE 12

| File Identification | Description | Value |
|---|---|---|
| 4FXX′ | PQC based Subscriber Concealed | Operator |
| | Identifier Calculation Information | dependent |

Table 13 indicates H.9 List of SFI Values at the DF 5GS Level.

TABLE 13

| File Identification | SFI | Description |
|---|---|---|
| 4FXX′ | XX′ | PQC based Subscriber Concealed |
| | | Identifier Calculation Information |

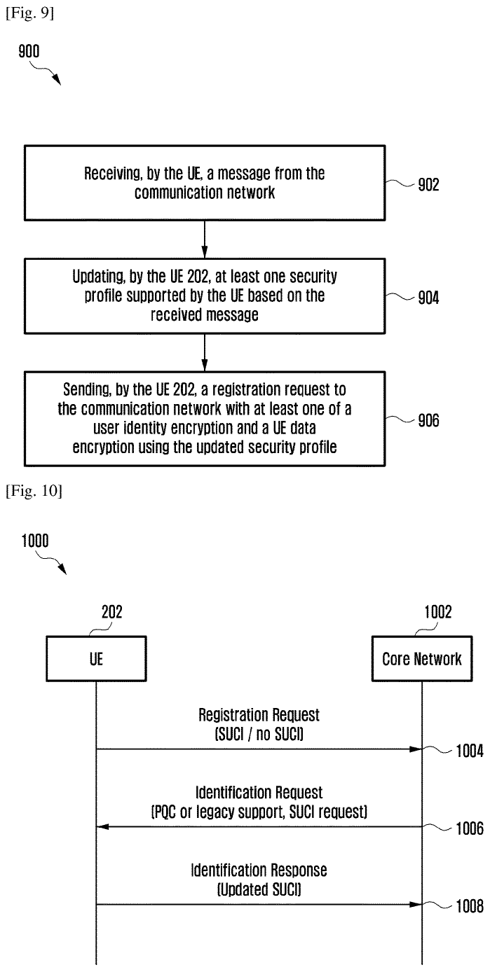

FIG. 9 illustrates a method 900 for selecting or updating a security profile based on a request from the communication network 204. The method 900 comprises receiving, by the UE 202, a message from the communication network 204, as depicted in step 902. The message comprises at least one of a security support indication and a security profile indication supported by the communication network 204. The security support indication comprises one of a PQC support indication and a legacy support indication. The security profile indication comprises one of a PQC profile indication supported by the communication network 204 and a legacy profile indication supported by the communication network 204. The message from the communication network 204 comprises at least one of an identity request message, a registration reject message, a SIB/MIB message, an RRC message, a BIP message, and a N1 message.

The method 900 comprises updating, by the UE 202, at least one security profile supported by the UE 202 based on the received message, as depicted in step 904. The method 900 comprises sending, by the UE 202, a registration request to the communication network 204 with at least one of a user identity encryption and a UE data encryption using the updated security profile, as depicted in step 906.

The various actions in method 900 may be performed in the order presented, in a different order or simultaneously. Further, in some embodiments, some actions listed in FIG. 9 may be omitted.

In an embodiment herein, a security profile selection or update can be performed by a core network. As PQC support and PQC profile depends on the core network, the core network can indicate the UE 202 with its support via various options so that the UE 202 can update its security profile. The options can be, but not limited to selection/update of PQC support via an identity request, selection/update of security profile via an identity request, selection/update of PQC support via a registration reject, selection/update of security profile via a registration reject, update of PQC support via any N1 message, and update of security profile via any N1 message.

FIG. 10 illustrates a message sequence diagram 1000 for selecting or updating of PQC support via an identity request. The UE 202 can either share SUCI with legacy/PQC security profile in a registration request, as depicted in step 1004. A core network 1002 may have different support with PQC/legacy security profiles. Instead of authentication failure or registration reject, the core network 1002 can inform the UE 202 with its PQC/Legacy support via an identity request requesting for sharing SUCI with new type of security profile (Legacy/PQC), as depicted in step 1006.

A provision can be provided by not mandating the UE 202 to send SUCI in the registration request, so that the core network 1002 can assume that the UE 202 does not know the legacy or PQC type of security profile to conceal SUPI and respond with the identity request with type of support. This solution can reduce delay in registration procedure time. If the core network 1002 is sending identity request for any other purpose, then the core network 1002 adds PQC/legacy support information element to let the UE 202 know the type of concealment required for SUCI. Later, an identification response is sent from the UE 202 to the core network 1002 with updated SUCI, as depicted in step 1008. A new Information Element Identifier (IEI) can be introduced or spare bits from existing IEI can be reused. Further, default legacy/PQC profiles can be used based on network support.

In an embodiment herein, the standard impact (TS 24.501) is given as,

### 8.2.21 Identity Request

### 8.2.21.1 Message Definition

The identity request message is sent by an Access & Mobility Management Function (AMF) to the UE 202 to request the UE 202 to provide specified identity.
Message type: IDENTITY REQUEST
Significance: dual
Direction: AMF to UE

Table 14 indicates IDENTITY REQUEST message content.

TABLE 14
Format Length

| | Information | | | | |
|---|---|---|---|---|---|
| IEI | Element | Type/Reference | Presence | Format | Length |
| | Extended protocol | Extended | M | V | 1 |
| | discriminator | protocol | | | |
| | | discriminator | | | |
| | | 9.2 | | | |
| | Security header | Security header | M | V | ½ |
| | type | type | | | |
| | | 9.3 | | | |
| | Spare half octet | Spare half octet | M | V | ½ |
| | | 9.5 | | | |
| | Identity request | Message type | M | V | 1 |
| | message identity | 9.7 | | | |
| | Identity type | 5GS identity | M | V | ½ |
| | | type | | | |
| | | 9.11.3.3 | | | |
| | Spare half octet → | PQC Support | O | V | ½ |
| | PQC_Support | type | | | |
| | | 9.11.3.XX | | | |

### 9.11.3.XX PQC Support

IEI for PQC support of one bit;

1-PQC support; 0-No PQC support.

PQC support indication can also be part of 5GS identity type

### 9.11.3.3 5GS Identity Type

The purpose of the 5GS identity type information element is to specify which identity is requested.

The 5GS identity type is a type 1 information element.

The 5GS identity type information element is coded as shown in table 15 and table 16.

TABLE 15

| | | | | | | | |
|---|---|---|---|---|---|---|---|
| 8 | 7 | 6 | 5 | 4 | 3 | 2 | 1 |

| 5GS identity type | 0 | Type of | octet 1 |
|---|---|---|---|
| IEI | Spare | identity | |
| | → PQC Support | | |
| | type | | |

TABLE 16
Type of identity (octet 1)

| Bits | | | |
|---|---|---|---|
| 3 | 2 | 1 | |
| 0 | 0 | 1 | SUCI |
| 0 | 1 | 0 | 5G-GUTI |
| 0 | 1 | 1 | IMEI |
| 1 | 0 | 0 | 5G-S-TMSI |
| 1 | 0 | 1 | IMEISV |
| 1 | 1 | 0 | MAC address |
| 1 | 1 | 1 | EUI-64 |

All other values are unused and shall be interpreted as “SUCI”, if received by the UE.

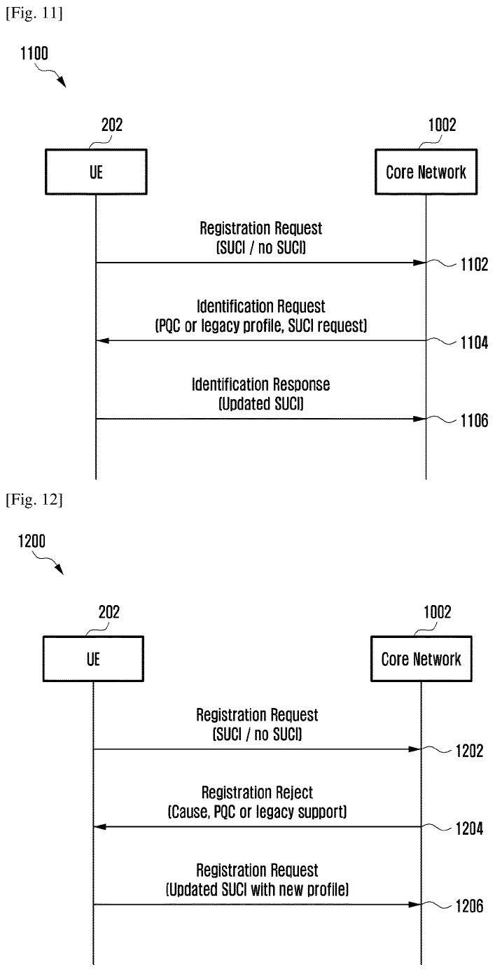

FIG. 11 illustrates a message sequence diagram 1100 for selecting or updating of security profile via an identity request. The UE 202 can either share SUCI with legacy/PQC security profile in registration request, as depicted in step 1102. The core network 1002 may have different security profile support. Instead of authentication failure or registration reject, the core network 1002 can inform the UE 202 with its PQC/legacy profile via identity request requesting for sharing SUCI with new type of security profile (legacy/PQC), as depicted in step 1104.

A provision can be provided by not mandating the UE 202 to send SUCI in the registration request. The core network 1002 can assume that the UE 202 does not know the security profile to conceal SUPI and respond with the identity request with correct security profile. This solution can reduce delay in the registration procedure time. If the core network 1002 is sending identity request for any other purpose also, then the core network 1002 adds security profile information element to let the UE 202 know the type of concealment required for SUCI. Later, an identification response is sent from the UE 202 to the core network 1002 with updated SUCI, as depicted in step 1106.

Table 17 indicates IDENTITY REQUEST message content.

TABLE 17

| | Information | | | | |
|---|---|---|---|---|---|
| IEI | Element | Type/Reference | Presence | Format | Length |
| | Extended protocol | Extended | M | V | 1 |
| | discriminator | protocol | | | |
| | | discriminator | | | |
| | | 9.2 | | | |
| | Security header | Security | M | V | ½ |
| | type | header | | | |
| | | type 9.3 | | | |
| | Spare half octet | Spare half octet | M | V | ½ |
| | | 9.5 | | | |
| | Identity request | Message type | M | V | 1 |
| | message identity | 9.7 | | | |
| | Identity type | 5GS identity type | M | V | ½ |
| | | 9.11.3.3 | | | |
| | Spare half octet → | Security Profile | O | V | ½ |
| | Security Profile | 9.11.3.XX | | | |

### 9.11.3.XX Security Profile

IEI for Security Profile ID of 4 bits to indicate security profile support for SUPI concealment. Table 18 indicates a security profile IEI.

TABLE 18

| | | | | | | | |
|---|---|---|---|---|---|---|---|
| 8 | 7 | 6 | 5 | 4 | 3 | 2 | 1 |

| Request type IEI | 0 | Security Profile ID | octet 1 |
|---|---|---|---|
| | Spare → | | |
| | Security | | |
| | Profile | | |

FIG. 12 illustrates a message sequence diagram 1200 for selecting or updating PQC support via a registration reject. The UE 202 can either share SUCI with legacy/PQC security profile in the registration request, as depicted in step 1202. The core network 1002 may have different support with PQC/legacy security profile. The core network 1002 can inform the UE 202 with its PQC/legacy support via a registration reject with cause code ‘yyy’ requesting for sharing SUCI with new type of security profile (legacy/PQC), as depicted in step 1204.

A provision can be provided by not mandating the UE 202 to send SUCI in the registration request. The core network 1002 can know that the UE 202 does not know the legacy or PQC type of security profile to conceal SUPI and respond with registration reject with type of support. If the core network 1002 is sending registration reject with cause code ‘yyy’ for any other purpose also, the core network 1002 adds PQC/legacy support information element to let the UE 202 know the type of concealment required for SUCI. Later, the UE 202 can send a registration request with SUPI concealed with new security profile type, as depicted in step 1206. The default legacy/PQC profile can be used based on network support.

### 8.2.9 Registration Reject

Table 19 indicates a new IEI. The new IEI can be introduced: PQC support type

TABLE 19

| | | | | |
|---|---|---|---|---|
| XX | PQC support | PQC support type | O | TLV |
| | type | 9.11.3.XX | | |

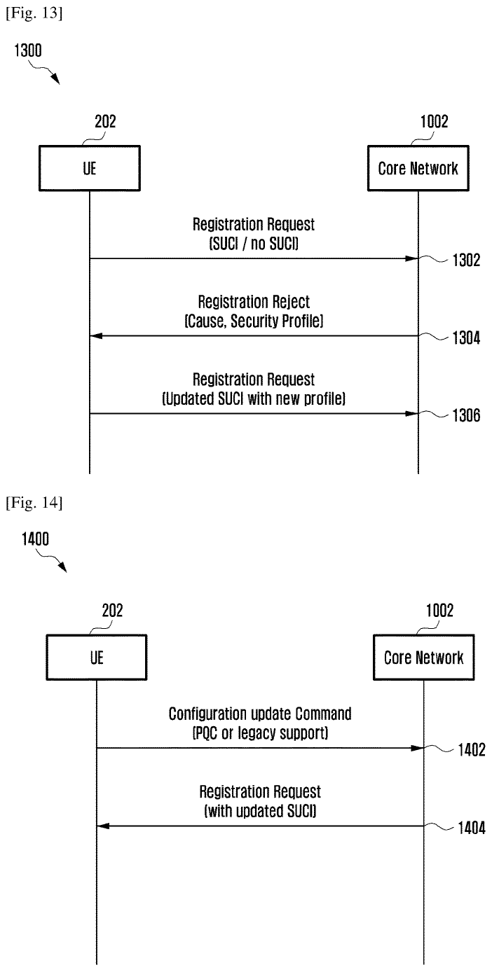

FIG. 13 illustrates a message sequence diagram 1300 for selecting or updating of security profiles via a registration reject. The UE 202 can either share SUCI with legacy/PQC security profiles in the registration reject, as depicted in step 1302. The core network 1002 may have different support with PQC/legacy security profiles. The core network 1002 can inform the UE 202 with its security profile via registration reject with cause code ‘yyy’ requesting for sharing SUCI with new type of security profile (Legacy/PQC), as depicted in step 1304.

A provision can also be provided by not mandating the UE 202 to send SUCI in the registration request. The core network 1002 can assume that the UE 202 does not know the legacy or PQC security profile to conceal SUPI and respond with the registration reject with updated security profile. If the core network 1002 is sending the registration reject with cause code ‘yyy’ for any other purpose also, the core network 1002 adds security profile information element to let the UE 202 know the type of concealment required for SUCI. The UE 202 can send a registration request with SUPI concealed with new security profile type, as depicted in step 1306.

FIG. 14 illustrates a message sequence diagram 1400 for updating of PQC support via configuration update command or any N1 message through registration request. The core network 1002 can update the UE 202 with its PQC/legacy support via any N1 message like a configuration update command message, as depicted in step 1402, requesting for sharing SUCI with new type of security profile (legacy/PQC) from next registration request. The UE 202 can send the registration request with SUPI concealed with new security profile type, as depicted in step 1404. The default legacy/PQC profile can be used based on network support.

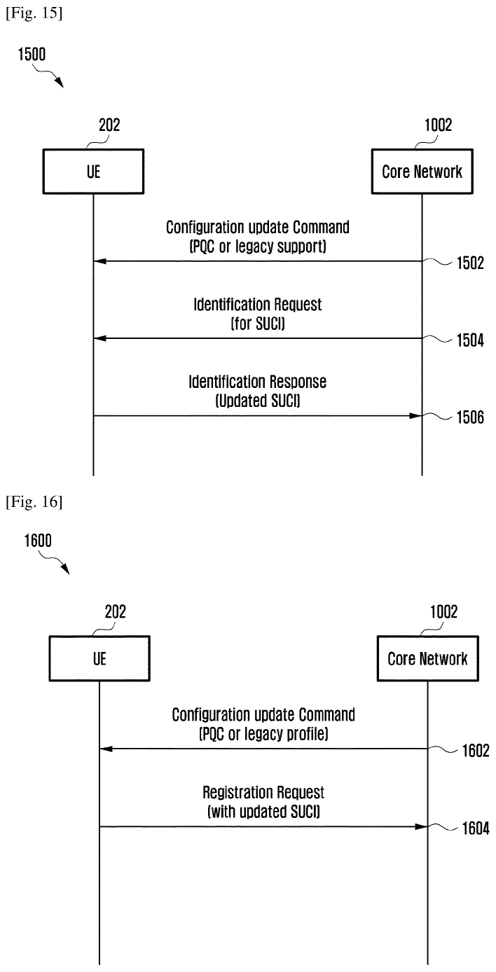

FIG. 15 illustrates a message sequence diagram 1500 for updating of PQC support via configuration update command or any N1 message through identification request. The core network 1002 can update the UE 202 with its PQC/legacy support via any N1 message like a configuration update command message, as depicted in step 1502, requesting for sharing SUCI with new type of security profile (legacy/PQC) from next identification response. The core network 1002 can send an identification request for SUCI to the UE 202, as depicted in step 1504. The UE 202 sends an identification response to the core network 1002 with SUPI concealed with new security profile type, as depicted in step 1506.

### 8.2.19 Configuration Update Command

Table 21 indicates a new IEI. The new IEI can be introduced for PQC support type.

TABLE 21

| | | | | |
|---|---|---|---|---|
| XX | PQC support type | PQC support type | O | TLV |
| | | 9.11.3.XX | | |

FIG. 16 illustrates a message sequence diagram 1600 for updating of security profile via configuration update command or any N1 message through registration request. The core network 1002 can update the UE 202 with its security profile via any N1 message like UE configuration update message, as depicted in step 1602, requesting for sharing SUCI with new type of security profile (legacy/PQC) from next registration request. The UE 202 can send the registration request with SUPI concealed with new security profile type, as depicted in step 1604.

FIG. 17 illustrates a message sequence diagram 1700 for updating of security profile via configuration update command or any N1 message through identification request. The core network 1002 can update the UE 202 with its security profile via any N1 message like UE configuration update message, as depicted in step 1702, requesting for sharing SUCI with new type of security profile (legacy/PQC) from next identification response. The core network 1002 can send an identification request to the UE 202 for SUCI, as depicted in step 1704. The UE 202 can send the identification response to the core network 1002 with SUPI concealed with new security profile type, as depicted in step 1706.

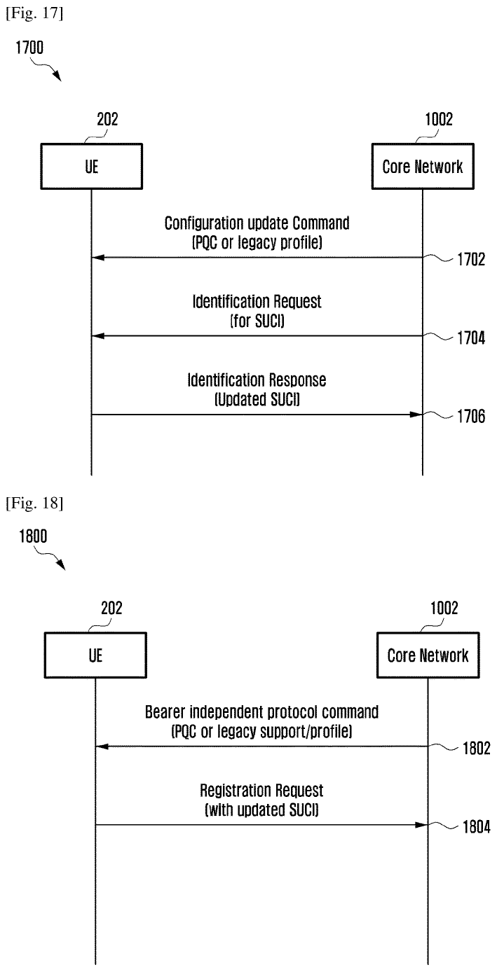

FIG. 18 illustrates a message sequence diagram 1800 for PQC/legacy support update or profile update via BIP session through registration request. The core network 1002 can update the UE 202 with its PQC/legacy support or security profile via any bearer independent protocol message, as depicted in step 1802, for requesting of sharing SUCI with new type of security profile (legacy/PQC) from next registration request. The UE 202 can send the registration request with SUPI concealed with new security profile type, as depicted in step 1804. The default legacy/PQC profile can be used based on network support.

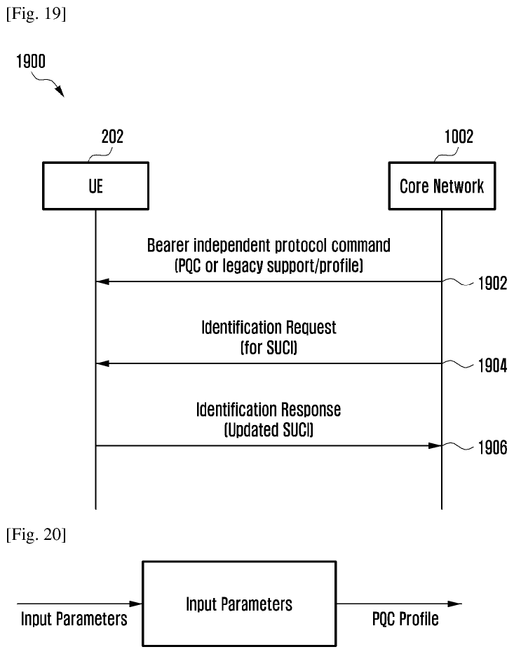

FIG. 19 illustrates a message sequence diagram 1900 for PQC/legacy support update or profile update via BIP session through identification request. The core network 1002 can update the UE 202 with its PQC/legacy support or security profile via any bearer independent protocol message, as depicted in step 1902, for requesting of sharing SUCI with new type of security profile (legacy/PQC) from next registration request. The core network 1002 can send an identification request to the UE 202 for SUCI, as depicted in step 1904. The UE 202 can send an identification response with SUPI concealed with new security profile type, as depicted in step 1906.

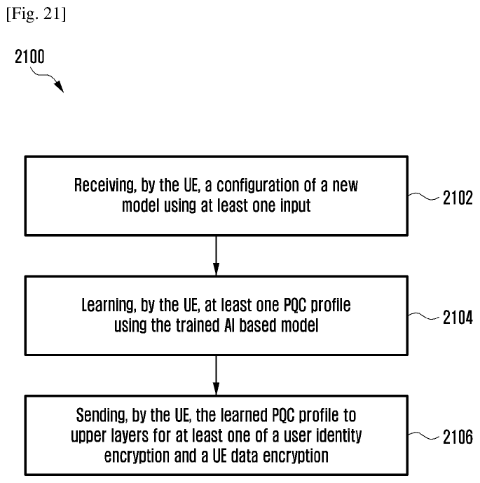

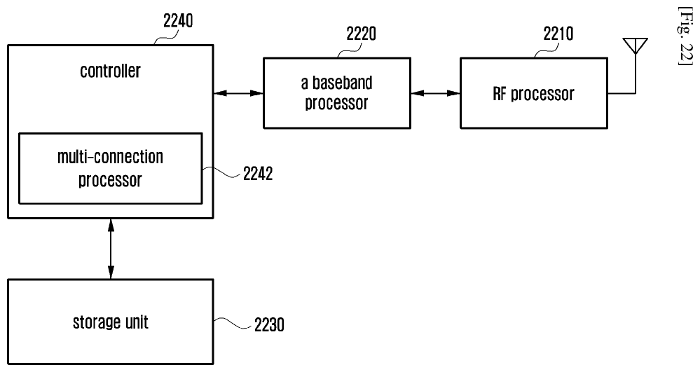

FIG. 20 illustrates a design of procedure for AI/ML based PQC profile selection. The ML/AI based model can be created and trained using input parameters of either UE parameters or network parameters or application parameters and PQC profile can be learnt there after from the created model. This PQC profile can be sent to upper layers for SUCI concealment or for any application usage. The UE parameters can be, but not limited to a UE type (such as Internet of Things (IOT) device/low power UE), a network slice type, supported level of security, one or more security algorithms supported by the UE 202, and so on. The network parameters can be, but not limited to physical cell ID, core network service provided name, and so on. The application parameters can be, but not limited to App ID which needs a PQC profile for authentication or signing purpose.

FIG. 21 illustrates a method 2100 for selecting a PQC profile in a communication network 204 through AI model. The method 2100 comprises creating, by the UE 202, and training a AI based model using at least one input comprising one of one or more, UE parameters, one or more network parameters and one or more application parameters, as depicted in step 2102. The method 2100 comprises learning, by the UE 202, at least one PQC profile using the trained AI based model, as depicted in step 2104. The method 2100 comprises sending, by the UE 202, the learned PQC profile to upper layers for at least one of a user identity encryption and a UE data encryption, as depicted in step 2106.

The various actions in method 2100 may be performed in the order presented, in a different order or simultaneously. Further, in some embodiments, some actions listed in FIG. 21 may be omitted.

Therefore, the proposed system 200 adopts PQC secured algorithms for beyond 5G networks to avoid threat from quantum machines which can break current asymmetric, symmetric and hash based cryptographic algorithms. The proposed system 200 adopts PQC secured algorithms especially for SUCI encryption/decryption during primary authentication where user privacy is utmost important.

The proposed method 500, 900, 2100 and signaling mechanism of profile selection procedure for beyond 5G network can support multiple types of crypto algorithm profiles such as 5G legacy algorithm and/or post quantum cryptography and/or quantum algorithm between the UE 202 and the communication network 204. The PQC/legacy profile selection based on UICC provisioning introduces new network service support elements and elementary file additions to UICC to support post quantum/quantum cryptography. The PQC/legacy profile selection by the core network provides selection/updating of PQC support and security profile via any N1 message. The proposed method 500, 900, 2100 provides PQC/legacy profile update via BIP session between the UE 202 and the communication network 204. The proposed method 500, 900, 2100 provides machine learning based PQC profile selection. The proposed method 500, 900, 2100 defines the N1/RRC/SIB/MIB message structure to support legacy, and post quantum or quantum based profile selection. The method 500, 900, 2100 provides indication of post quantum or quantum support to the UE 202 from the communication network 204. The method 500, 900, 2100 provides indication of post quantum or quantum profile to the UE 202 from the communication network 204. The method 500, 900, 2100 provides new state machines at the UE 202 and the communication network 204 for maintaining post-quantum state. Thus, Post Quantum Cryptography is considered as one of the essential technologies for security in 6G.

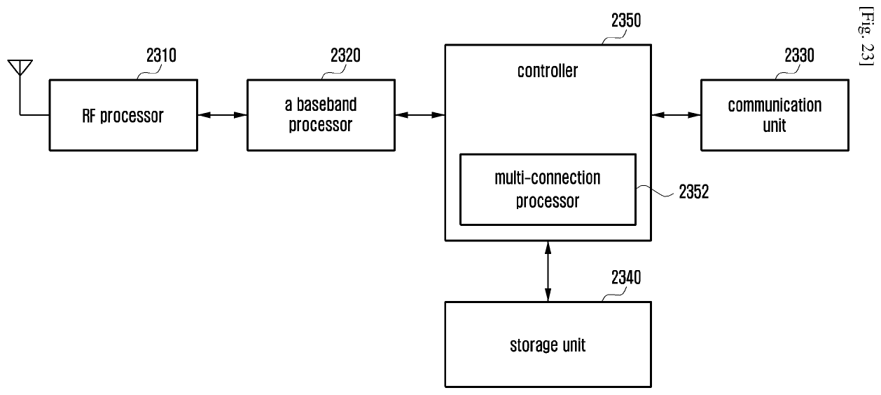

The structure of the UE to which embodiments of the disclosure can be applied is illustrated in FIG. 22.

Referring to FIG. 22, the UE includes a radio frequency (RF) processor 2210, a baseband processor 2220, a storage unit 2230, and a controller 2240.

The RF processor 2210 performs a function for transmitting and receiving a signal through a wireless channel, such as band conversion and amplification of a signal. That is, the RF processor 2210 up-converts a baseband signal provided from the baseband processor 2220 into an RF band signal, transmits the RF band signal through an antenna, and then down-converts the RF band signal received through the antenna into a baseband signal. For example, the RF processor 2210 may include a transmission filter, a reception filter, an amplifier, a mixer, an oscillator, a digital-to-analog converter (DAC), an analog-to-digital converter (ADC), and the like. Although FIG. 22 illustrates only one antenna, the UE may include a plurality of antennas. In addition, the RF processor 2210 may include a plurality of RF chains. Moreover, the RF processor 2210 may perform beamforming. For the beamforming, the RF processor 2210 may control a phase and a size of each signal transmitted/received through a plurality of antennas or antenna elements. The RF processor may perform MIMO and receive a plurality of layers when performing the MIMO operation. The RF processor 2210 may appropriately configure a plurality of antennas or antenna elements according to the control of the controller to perform reception beam sweeping or control a direction of a reception beam and a beam width so that the reception beam corresponds to a transmission beam.

The baseband processor 2220 performs a function for a conversion between a baseband signal and a bitstream according to a physical layer standard of the system. For example, when data is transmitted, the baseband processor 2220 generates complex symbols by encoding and modulating a transmission bitstream. Further, when data is received, the baseband processor 2220 reconstructs a reception bitstream by demodulating and decoding a baseband signal provided from the RF processor 2210. For example, in an orthogonal frequency division multiplexing (OFDM) scheme, when data is transmitted, the baseband processor 2220 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 2220 divides the baseband signal provided from the RF processor 2210 in the unit of OFDM symbols, reconstructs the signals mapped to the subcarriers through a fast Fourier transform (FFT) operation, and then reconstructs a reception bitstream through demodulation and decoding.

The baseband processor 2220 and the RF processor 2210 transmit and receive signals as described above. Accordingly, the baseband processor 2220 and the RF processor 2210 may be referred to as a transmitter, a receiver, a transceiver, or a communication unit. Further, at least one of the baseband processor 2220 and the RF processor 2210 may include a plurality of communication modules to support a plurality of different radio access technologies. In addition, at least one of the baseband processor 2220 and the RF processor 2210 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 2230 stores data such as basic program, an application, and setting information for the operation of the UE. The storage unit 2230 provides the stored data according to a request from the controller 2240.

The controller 2240 controls the overall operation of the UE. For example, the controller 2240 transmits/receives a signal through the baseband processor 2220 and the RF processor 2210. In addition, the controller 2240 may record data in the storage unit 2230 and read the data. To this end, the controller 2240 may include at least one processor. For example, the controller 2240 may include a communication processor (CP) that performs a control for communication, and an application processor (AP) that controls a higher layer such as an application program.

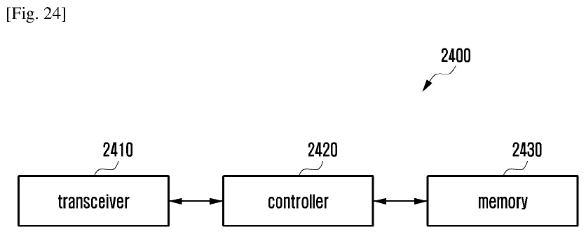

FIG. 23 illustrates a block diagram of a base station in a wireless communication system to which embodiments of the disclosure can be applied.

As illustrated in FIG. 23, the base station includes an RF processor 2310, a baseband processor 2320, a backhaul communication unit 2330, a storage unit 2340, and a controller 2350.

The RF processor 2310 performs a function for transmitting and receiving a signal through a wireless channel, such as band conversion and amplification of a signal. That is, the RF processor 2310 up-converts a baseband signal provided from the baseband processing unit 2320 into an RF band signal and then transmits the converted signal through an antenna, and down-converts an RF band signal received through the antenna into a baseband signal. For example, the RF processor 2310 may include a transmission filter, a reception filter, an amplifier, a mixer, an oscillator, a DAC, and an ADC. Although FIG. 23 illustrates only one antenna, the first access node may include a plurality of antennas. In addition, the RF processor 2310 may include a plurality of RF chains. Moreover, the RF processor 2310 may perform beamforming. For the beamforming, the RF processor 2310 may control a phase and a size of each of the signals transmitted and received through a plurality of antennas or antenna elements. The RF processor may perform a downlink MIMO operation by transmitting one or more layers.

The baseband processor 2320 performs a function of performing conversion between a baseband signal and a bitstream according to a physical layer standard of the first radio access technology. For example, when data is transmitted, the baseband processor 2320 generates complex symbols by encoding and modulating a transmission bitstream. Further, when data is received, the baseband processor 2320 reconstructs a reception bitstream by demodulating and decoding a baseband signal provided from the RF processor 2310. For example, in an OFDM scheme, when data is transmitted, the baseband processor 2320 may generate complex symbols by encoding and modulating the transmission bitstream, map the complex symbols to subcarriers, and then configure OFDM symbols through an IFFT operation and CP insertion. In addition, when data is received, the baseband processor 2320 divides a baseband signal provided from the RF processor 2310 in units of OFDM symbols, recovers signals mapped with sub-carriers through an FFT operation, and then recovers a reception bitstream through demodulation and decoding. The baseband processor 2320 and the RF processor 2310 transmit and receive signals as described above. Accordingly, the baseband processor 2320 and the RF processor 2310 may be referred to as a transmitter, a receiver, a transceiver, or a communication unit.

The communication unit 2330 provides an interface for communicating with other nodes within the network.

The storage unit 2340 stores data such as a basic program, an application, and setting information for the operation of the MeNB. Particularly, the storage unit 2340 may store information on bearers allocated to the accessed UE and the measurement result reported from the accessed UE. Further, the storage unit 2340 may store information on a reference for determining whether to provide multiple connections to the UE or stop the multiple connections. In addition, the storage unit 2340 provides data stored therein according to a request from the controller 2350.

The controller 2350 controls the overall operation of the MeNB. For example, the controller 2350 transmits and receives a signal through the baseband processor 2320 and the RF processor 2310 or through the backhaul communication unit 2330. In addition, the controller 2350 may record data in the storage unit 2340 and read the data. To this end, the controller 2350 may include at least one processor.

Although the present disclosure has been described with various embodiments, various changes and modifications may be suggested to one skilled in the art. It is intended that the present disclosure encompass such changes and modifications as fall within the scope of the appended claims.

FIG. 24 is a diagram of a configuration of a network entity, according to an embodiment. The network entity may correspond to the AMF node in the respective embodiments. Referring to FIG. 24, the network entity may include a transceiver 2410, a controller 2420, and a storage unit 2430. The controller 2420 may be defined as a circuit, an application-specific integrated circuit, or at least one processor.

The transceiver 2410 may transmit/receive signals to/from other network entities. The controller 2420 may control overall operations of the UE. The storage unit 2430 may store at least one piece of information transmitted/received through the transceiver 2410 and information produced through the controller 2420.

Various embodiments of the present disclosure may be implemented by software including an instruction stored in a machine-readable storage media readable by a machine (e.g., a computer). The machine may be a device that calls the instruction from the machine-readable storage media and operates depending on the called instruction and may include the electronic device. When the instruction is executed by the processor, the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiment disclosed herein describes methods and systems 200 to design mechanisms and procedures involved in selection of security profiles for wireless communication networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by a user equipment (UE) in a wireless communication systems, the method comprising:
receiving, from a network entity, configuration information for a new network service of an universal integrated circuit card (UICC);
configuring at least one security profile identifier in one of the UE and the UICC for adding at least one security profile in a priority order; and
based on the configuration information, selecting the at least one security profile using the at least one configured security profile identifier.

2. The method of claim 1,
wherein the at least one security profile includes at least one of a legacy profile or a post quantum cryptography (PQC) profile,
wherein the at least one security profile identifier is configured as a combined section for the legacy profile and the PQC profile, and
wherein one or more security profile identifiers are configured as separate sections for the legacy profile and the PQC profile.

3. The method of claim 1,
wherein the new network service includes an independent network service and a dependent network service,
wherein the independent network service is independent of an existing network service,
wherein the dependent network service is dependent of the existing network service, and
wherein the new network service is configured in the UICC for enabling an use of one or more PQC algorithms for performing at least one of a user identity encryption and a UE data encryption.

4. The method of claim 3, selecting the at least one security profile comprising:
verifying the new network service;
in case that the new network service is the independent network service and enabled, performing the at least one of the user identity encryption and the UE data encryption using a PQC profile;
in case that the new network service is the independent network service and is disabled, performing the at least one of the user identity encryption and the UE data encryption using a legacy profile; and
selecting the at least one security profile identifier among the legacy profile and the PQC profile with a high priority.

5. The method of claim 3, selecting the at least one security profile comprising:
verifying the new network service;
in case that the new network service is the dependent network service and the existing network service and the dependent network service both are enabled, performing the at least one of the user identity encryption and the UE data encryption using a PQC profile;
in case that if the new network service is the dependent network service, and one of the existing network service and the dependent network service is disabled, performing the at least one of the user identity encryption and the UE data encryption using a legacy profile; and
selecting the at least one security profile identifier among the legacy profile and the PQC profile with high priority.

6. The method of claim 1, further comprising:
receiving, from the network entity, a message for updating the at least one security profile, wherein the message includes at least one of a security support indication and a security profile indication;
based on the received message, updating, the at least one security profile; and
based on the at least one updated security profile, transmitting, to the communication network, a registration request message including at least one of a user identity encryption and a UE data encryption.

7. A method performed by a network entity in a wireless communication systems, the method comprising:
generating configuration information for a new network service of an universal integrated circuit card (UICC); and
transmitting, to a user equipment (UE), the configuration information for the new network service of the UICC;
wherein at least one security profile identifier in one of the UE and the UICC is configured for adding at least one security profile in a priority order, and
wherein the at least one security profile is selected using the at least one configured security profile identifier based on the configuration information.

8. The method of claim 1,
wherein the at least one security profile includes at least one of a legacy profile or a post quantum cryptography (PQC) profile,
wherein the at least one security profile identifier is configured as a combined section for the legacy profile and the PQC profile, and
wherein one or more security profile identifiers are configured as separate sections for the legacy profile and the PQC profile.

9. A user equipment (UE) in a wireless communication systems, the US comprising:
a transceiver; and
a controller configured to:
receive, from a network entity, configuration information for a new network service of an universal integrated circuit card (UICC),
configure at least one security profile identifier in one of the UE and the UICC for adding at least one security profile in a priority order, and based on the configuration information, select the at least one security profile using the at least one configured security profile identifier.

10. The UE of claim 9,
wherein the at least one security profile includes at least one of a legacy profile or a post quantum cryptography (PQC) profile,
wherein the at least one security profile identifier is configured as a combined section for the legacy profile and the PQC profile, and
wherein one or more security profile identifiers are configured as separate sections for the legacy profile and the PQC profile.

11. The UE of claim 9,
wherein the new network service includes an independent network service and a dependent network service,
wherein the independent network service is independent of an existing network service,
wherein the dependent network service is dependent of the existing network service, and
wherein the new network service is configured in the UICC for enabling an use of one or more PQC algorithms for performing at least one of a user identity encryption and a UE data encryption.

12. The UE of claim 11, wherein the controller is further configured to:
verify the new network service,
in case that the new network service is the independent network service and enabled, perform the at least one of the user identity encryption and the UE data encryption using a PQC profile,
in case that the new network service is the independent network service and is disabled, perform the at least one of the user identity encryption and the UE data encryption using a legacy profile, and
select the at least one security profile identifier among the legacy profile and the PQC profile with a high priority.

13. The UE of claim 11, wherein the controller is further configured to:
verify the new network service,
in case that the new network service is the dependent network service and the existing network service and the dependent network service both are enabled, perform the at least one of the user identity encryption and the UE data encryption using a PQC profile,
in case that if the new network service is the dependent network service, and one of the existing network service and the dependent network service is disabled, perform the at least one of the user identity encryption and the UE data encryption using a legacy profile, and
select the at least one security profile identifier among the legacy profile and the PQC profile with high priority.

14. The UE of claim 11, wherein the controller is further configured to:
receive from the network entity, a message for updating the at least one security profile, wherein the message includes at least one of a security support indication and a security profile indication,
based on the received message, update, the at least one security profile, and
based on the at least one updated security profile, transmit, to the communication network, a registration request message including at least one of a user identity encryption and a UE data encryption.

15. A network entity in a wireless communication systems, the network entity comprising:
a transceiver; and
a controller configured to:
generate configuration information for a new network service of an universal integrated circuit card (UICC), and
transmit, to a user equipment (UE), the configuration information for the new network service of the UICC,
wherein at least one security profile identifier in one of the UE and the UICC is configured for adding at least one security profile in a priority order, and
wherein the at least one security profile is selected using the at least one configured security profile identifier based on the configuration information.
